(19) United States
(12) Patent Application Publication
(10) Pub. No.: US 2026/0299938 A1
(43) Pub. Date: Oct. 1, 2026

(54) METHODS, SYSTEMS, AND COMPUTER READABLE MEDIA FOR IDENTIFYING SOFTWARE COMPONENTS OF BINARY FILES

(71) Applicant: Keysight Technologies, Inc., Santa Rosa, CA (US)

(72) Inventors: Behrang Fouladi Azarnaminy, Woking (GB); Danny Jay Huang, Long Beach, CA (US); Evgeny Aleksandrovich Shuvalov, Glasgow (GB)

(21) Appl. No.: 19/280,166

(22) Filed: Jul. 25, 2025

Related U.S. Application Data
(60) Provisional application No. 63/780,834, filed on Mar. 31, 2025.

(51) Int. Cl. G06F 8/71

(52) U.S. Cl. CPC G06F 8/71

(57) ABSTRACT

A method for identifying software components of target binary files includes generating, from ground truth binary files, a vectorized database of vectors representing program level features of the ground truth binary, receiving, as input, a target binary file to be analyzed, and vectorizing the target binary file to generate vectors representing program level features of the target binary file. The method further includes comparing the vectors generated from the target binary file to the vectors in the vectorized database and generating corresponding output. The method further includes identifying version-returning functions based on data flow analysis of the target binary file and emulating execution of at least one of the version-returning functions to identify a version string that identifies a version of a program implemented by the target binary file.

### PRIORITY CLAIM

This application claims the priority benefit of U.S. Provisional Patent Application Ser. No. 63/780,834, filed Mar. 31, 2025, the disclosure of which is incorporated herein by reference in its entirety.

### TECHNICAL FIELD

The subject matter described herein relates to analyzing binaries to identify software components that make up the binaries. More particularly, the subject matter described herein relates to identifying software components of binary files, including, but not limited to, firmware binary image files.

### BACKGROUND

Firmware software composition analysis (SCA) refers to the analysis of firmware image files in binary format to identify open-source software libraries, commercial software libraries, operating systems, and software development kits (SDKs) embedded in the firmware. The goal of firmware SCA is typically to output a software bill of materials (SBOM) that lists all software components, versions, and other metadata (licenses, descriptions, etc.). Firmware SCA can be used for vulnerability analysis, licensing compliance, patch management, etc.

Firmware SCA is becoming increasingly important in the Internet of Things (IoT) space to identify software components embedded in IoT device firmware to assess vulnerabilities. Two types of firmware SCA are packet manager SCA and binary analysis based SCA. Package manager SCA integrates package managers, such as npm, maven, and cargo, to scan firmware manifest files, which are text files to identify names and versions of software components. One problem with firmware SCA is that not all firmware images include a manifest file, and package manager SCA cannot be used without a manifest file. Traditional binary analysis based SCA relies on computing hash values of disassembled function codes in firmware image files and comparing those hashes to hashes of known library functions. However, using hash functions of known libraries requires separate hash functions to be created for the same library compiled for execution on a different operating system and/or compiled with a different compiler, making such an approach unscalable.

In light of these and other difficulties, there exists a need for improved methods, systems, and computer readable media for binary image-based analysis of firmware and other binary files to identify their component parts.

### SUMMARY

A method for identifying software components of binary files includes generating, from ground truth binary files, a vectorized database of vectors representing program level features of the ground truth binary files. The method further includes receiving, as input, a target binary file to be analyzed. The method further includes vectorizing the target binary file to generate vectors representing program level features of the target binary file. The method further includes comparing the vectors generated from the target binary file to the vectors in the vectorized database. The method further includes identifying version-returning functions based on data flow analysis of the target binary file and emulating execution of at least one of the version-returning functions to identify a version string that identifies a version of a program implemented by the target binary file. The method further includes generating, as output and based on the results of the comparing, at least one identity of at least one software component of the target binary file. The method further includes outputting the version string.

According to another aspect of the subject matter described herein, generating the vectorized database of vectors representing the program level features of the ground truth binary files includes identifying strings accessed by code and names of exported functions of the ground truth binary files.

According to another aspect of the subject matter described herein, receiving, as input, the target binary file to be analyzed includes receiving the target binary file obtained from scanning firmware for executable files or library files.

According to another aspect of the subject matter described herein, vectorizing the target binary file to generate vectors representing program level features of the target binary file includes identifying strings accessed by code and names of exported functions of the target binary file.

According to another aspect of the subject matter described herein, comparing the vectors generated from the target binary file to the vectors in the database includes generating a similarity metric quantifying similarity between a feature vector generated from the target binary file and a feature vector in the database.

According to another aspect of the subject matter described herein, generating the similarity metric includes generating a cosine similarity metric.

According to another aspect of the subject matter described herein, generating, as output and based on results of the comparison, at least one identity of at least one software component in the target binary file includes identifying a software component library name based on the results of the comparison.

According to another aspect of the subject matter described herein, the method for identifying software components of a target binary file includes generating an emulation rules database by analyzing the ground truth binary files to return names of version-returning functions from the ground truth binary files that return a version string when called with specified arguments The method of claim 8 comprising attempting to identify a version string from the target binary file by analyzing the target binary file to identify the presence of one of the version-returning functions having its name recorded in the emulation rules database and that returns a version string or writes the version string to a file or an I/O interface and wherein emulating execution of at least one of the version-returning functions to identify a version string that identifies the version of the program implemented by the target binary file includes emulating execution of the at least one version-returning function to obtain the version string returned or written to an input/output (I/O) interface by the at least one version-returning function.

According to another aspect of the subject matter described herein, emulating execution of at least one of the version-returning functions to obtain the version string includes locating binary code for the at least one version-returning function in the target binary file, converting the binary code for the version-returning function into an intermediate code format, emulating execution of the version-returning function in the intermediate code format, and obtaining the version string resulting from emulation of the version-returning function in the intermediate code format.

According to another aspect of the subject matter described herein, A system for identifying software components of binary files is provided. The system includes a computing platform including at least one processor and memory. The system further includes a binary analyzer implemented by the at least one processor for generating, from ground truth binary files, a vectorized database of vectors representing program level features of the ground truth binary files and storing the vectorized database in the memory. The system further includes a similarity matcher implemented by the at least one processor for receiving, as input, a target binary file to be analyzed, vectorizing the target binary file to generate vectors representing program level features of the target binary file, comparing the vectors generated from the target binary file to the vectors in the vectorized database, and generating, as output and based on the results of the comparing, at least one identity of at least one software component of the target binary file. The system further includes a version extractor for identifying version-returning functions based on data flow analysis of the target binary file and emulating execution of at least one of the version-returning functions to identify a version string that identifies a version of a program implemented by the target binary file and outputting the version string.

According to another aspect of the subject matter described herein, the binary analyzer is configured to generate the vectorized database of vectors representing the program level features of the ground truth binary files includes identifying strings accessed by code and names of exported functions of the ground truth binary files.

According to another aspect of the subject matter described herein, the target binary file to be analyzed is obtained from scanning firmware for executable files or library files.

According to another aspect of the subject matter described herein, the binary analyzer is configured to vectorize the target binary file to generate vectors representing program level features of the target binary file by identifying strings accessed by code and names of exported functions of the target binary file.

According to another aspect of the subject matter described herein, the similarity matcher is configured to compare the vectors generated from the target binary file to the vectors in the database by generating a similarity metric quantifying similarity between a feature vector generated from the target binary file and a feature vector in the database.

According to another aspect of the subject matter described herein, the similarity metric comprises a cosine similarity metric.

According to another aspect of the subject matter described herein, the system for identifying software components of a target binary file includes an emulation rules database generator for generating an emulation rules database by analyzing the ground truth binary files to return names of version-returning functions from the ground truth binary files that return a version string when called with specified arguments.

According to another aspect of the subject matter described herein, the version extractor is configured for attempting to identify a version string from the target binary file by analyzing the target binary file to identify the presence of one of the version-returning functions having its name recorded in the emulation rules database and that returns a version string or writes the version string to a file or an I/O interface and wherein emulating execution of at least one of the version-returning functions to identify a version string that identifies the version of the program implemented by the target binary file includes emulating execution of the at least one version-returning function to obtain the version string returned or written to an input/output (I/O) interface by the at least one version-returning function.

According to another aspect of the subject matter described herein the version extractor is configured to emulate execution of at least one of the version-identifying to obtain the version string by locating binary code for the exported function in the target binary file, converting the binary code for the function into an intermediate code format, emulating execution of the version-returning function in the intermediate code format, and obtaining the version string resulting from emulation of the version-returning function in the intermediate code format.

According to another aspect of the subject matter described herein, a non-transitory computer readable medium having stored thereon executable instructions that when executed by a processor of a computer controls the computer to perform steps is provided. The steps include generating, from ground truth binary files, a vectorized database of vectors representing program level features of the ground truth binary files. The steps further include receiving, as input, a target binary file to be analyzed. The steps further include vectorizing the target binary file to generate vectors representing program level features of the target binary file. The steps further include comparing the vectors generated from the target binary file to the vectors in the vectorized database. The steps further include identifying version-returning functions based on data flow analysis of the target binary file and emulating execution of at least one of the version-returning functions to identify a version string that identifies a version of a program implemented by the target binary file. The steps further include generating, as output and based on the results of the comparing, at least one identity of at least one software component of the target binary file. The steps further include outputting the version string.

Once the software components in the target binary have been identified, they can be compared with a database of program names and versions with known security vulnerabilities to determine whether any of the components have a known security vulnerability. In another example, the identified component names and versions can be compared with a software licensing database to identify third party licenses corresponding to the software components.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a readable computer medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a block diagram illustrating a system for identifying software components in binary files;

FIG. 2 is a flow chart illustrating an exemplary process for generating emulation rules; and

FIG. 3 is a flow chart illustrating an exemplary process for emulation rules to identify a version of a software component.

### DETAILED DESCRIPTION

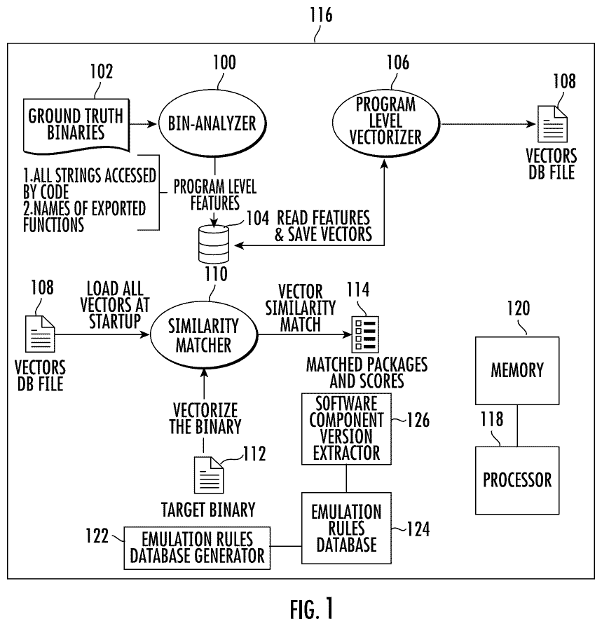

The subject matter described herein includes a vectorized approach for identifying software components embedded in binary files. The approach includes creating a vectorized database of text strings and program level features from ground truth binaries, vectorizing a target binary file, and comparing the vectors generated for the target binary file with vectors in the database to identify software components in the target binary file. FIG. 1 is a block diagram illustrating a system for identifying software components in binary files. In FIG. 1, the topmost portion illustrates components for generating a vectorized software component database from ground truth binaries, i.e., binaries corresponding to software components whose name and version number are known. In the illustrated example a binary analyzer 100 receives, as inputs, ground truth binaries, extracts program level features 104, such as text strings and names of exported functions, from the ground truth binaries. A program level vectorizer 106 vectorizes the extracted features and stores the vectors in a vectorized software components database 108.

The lowermost part of the FIG. 1 illustrates the use of vectorized software components database 108 to identify software components of a target binary file. A similarity matcher 110 receives, as input, a target binary file 112, vectorizes the target binary file, determines similarity metrics between the vectors generated from target binary file 112 and vectors in vectorized software components database 108, and generates, based on the similarity metrices, matched software component packages and similarity scores 114. The components illustrated in FIG. 1 may be implemented on a computing platform 116 including at least one processor 118 and memory 120.

The system illustrated in FIG. 1 may further include an emulation rules database generator 122 that generates an emulation rules database 124 of software component version identification rules, and a software version extractor 126 that uses the rules to identify a version of an identified software component.

### Generation of Vectorized Software Components Database

The following section describes exemplary operations implemented by binary analyzer 100 and program level vectorizer 106 to generate vectorized software components database 108.

### Collect Source Files

Source files are tagged with known metadata such as CPE product/vendor, licenses, source/package/binary name.

Metadata such as source/package/binary names will also be used to generate a list of reserved values.

### Extract Source File Data

Binary analyzer 100 extracts data containing useful identifiers is extracted from ground truth binaries 102. In one example, binary analyzer 100 extracts string literals accessed by program code that are likely to facilitate software component identification and exported function names from ground truth binaries 102.

### Strings

In one example, ground truth binaries 102 are binaries of executable library function (ELF) files. However, the subject matter described herein is not limited to identifying software components of executable library function (ELF) files. Identifying software components of any type of binary file is intended to be within the scope of the subject matter described herein. When ground truth binaries 102 are ELF files, binary analyzer 100 may extract the strings from the ELF .rodata section of a ground truth binary 102.

### Exported Functions

Exported functions are functions published or announced by a program and used to access program functionality. For ELF files, binary analyzer 100 may read the names of exported functions from ELF .dynsym and .symtab sections of a ground truth binary 102.

Binary analyzer 100 may process the exported functions by demangle exported C++ functions. Demangling exported C++ functions includes identifying functions that have the same name but have different arguments and generating new function names with different characters to account for the different arguments.

Once binary analyzer 100 has extracted the string literals accessed by program code and the exported functions, binary analyzer 100 tokenizes the extracted string literals and exported function names. Tokenizing the character literals and exported function names may include identifying discrete useful tokens that will be vectorized. Only useful tokens are retained to avoid flooding the vector sparse matrix and avoid hash collisions.

### Tokenize Ground Truth File Data

Binary analyzer 100 may utilize the following rules to determine usefulness of strings and exported function names:

### Strings

1. Split strings by common separators (spaces, commas, brackets . . . , etc.) into prospective tokens.
2. Remove tokens that may be garbled (predictable alphanumeric sequences or containing symbols).
3. Remove all lowercase alphabetical tokens that are not in a list of reserved values. This assumes most common English terms will be lowercase.
4. Extract filenames from assumed absolute file path tokens (strings starting with /).
5. If the token is snake case (function names separated by underscore characters), enter the prefix as a separate token. This assumes most snake case strings are function names or constants where the prefix is relevant to the package.
6. If the token contains hyphens, enter the prefix as a separate token. This assumes hyphenated strings could be version strings where the prefix is relevant to the package.
7. Remove tokens that may be too short or too long. In one example, the length range used to determine whether tokens are too short are too long may be 3<length<32.
8. Remove tokens from a custom curated list of common stop words (such as common c functions, client-server terms, copyright text, etc.)

### Exported Functions

Exported Functions data should already be a list of function names that are unique/useful to the packages. All strings are tokenized.

### Vectorize Data

After extracting and tokenizing strings and exported function names, binary analyzer 100 vectorizes the tokens. In one example, binary analyzer 100 uses the python sklearn.Hashing Vectorizer (https://scikit-learn.org/1.5/modules/generated/sklearn.feature_extraction.text.HashingVectorizer.html) to run a TF (term frequency) transform on the strings and exported function names. The term frequency transform is as follows:

$$TF ( t , d ) = count ( t , d ) / S ( d ) ,$$

where TF( ) is the term frequency transform,
t is the term,
d is the term frequency, and
S(d) is the total number of strings in file.

Binary analyzer 100 stores file vectors as scipy.SparseMatrix (https://docs.scipy.org/doc/scipy/reference/sparse.html)
Matrix rows represent file vectors.
Matrix columns represent features, where column index is the hashed (murmur3 hash) value of an extracted token.
Max Column size (n_features param) is arbitrarily set to 2²⁰, hashes that exceed this limit are wrapped with a size modulo.

### Strings

Binary analyzer 100 normalizes term frequency vectors for strings using l2 normalization.

### Exported Functions

TF vectors for exported function names are not required to be normalized because term frequency vectors for exported function names should all have value of 1 (functions only exported once)

### Aggregate Vectors

Binary analyzer 100 aggregates and transforms the source file vectors using a TF-IDF algorithm as follows.
1. TFₐ (aggregated term frequency) is generated as:

$${TF}_{a} = {TF}_{1} ⊕ {TF}_{2} … ⊕ {TF}_{n} ,$$

where
   TF₁ . . . . TFₙ are individual file vectors, and ⊕ is the concatenation function.
2. DF (document frequency) is calculated by counting TFₐ columns per source package.
   In other words, a token is only counted once per source package, this prevents multiple versions of the same package from skewing the document frequency.
3. IDF (inverse document frequency) is generated as:

$$IDF ( t , d ) = log ( N / ( 1 + DF ( t ) )$$

N is total number of source packages files in the database
4. TF-IDF is generated as:

$$TF - IDF = {TF}_{a}^{*} IDF$$

### Filter Vectors

After aggregating the vectors, binary analyzer 100, using TF-IDF data, drops (i.e., omits or removes from database 108) tokens that are considered too common. The filtering performed by binary analyzer 100 assumes that terms with high document frequency between source packages are not useful for generating matches.

### Scaled Tokens

Binary analyzer 100 may generate a sparse matrix (denoted as ST) of tokens which may have special significance for each file vector is also generated for weighted matches. One example of tokens that may have special significance to a file vector are source and binary names. For example, the term “OpenSSL” may be used in software packages that are like OpenSSL but do not include OpenSSL code. It may be desirable to count occurrences of “OpenSSL” in such packages.

### Storage Format

To create a version of database 108 that is suitable to be exported, binary analyzer 100 may convert matrices into a binary format and store the binary in an h5 file format (https://en.wikipedia.org/wiki/Hierarchical_Data_Format) where:
H5 Group Name→feature_name (strings, exported_funcs)
   Table 1 below illustrates the export file format:

TABLE 1
Export File Format

| Dataset | Value |
|---|---|
| packages | JSON string that contains package metadata for each row in |
| | TF-IDF matrix. |
| vector_ids | string List that contains vector metadata for each row in |
| | TF-IDF matrix. |
| matrix | Binary matrix that contains aggregated TF-IDF matrix. |
| idf | Binary matrix that contains IDF matrix (single row with |
| | aggregated TF columns), required to generate TF-IDF from |
| | target binary |
| scaler | Binary matrix that contains token scalers for significant |
| | terms per vector |

### EXAMPLES

The following are examples of character and exported function extraction, tokenization, and vectorization steps that may be performed by binary analyzer 100 for a ground truth binary 102. The ground truth binary for this example is found at the following URL: http://ftp.ubuntu.com/ubuntu/pool/main/libi/libidn/libidn12_1.38-4build1_amd64.deb

contains a single elf_file/usr/lib/x86_64-linux-gnu/libidn.so.12.6.3

### Strings

Table 2 is an example of character strings extracted by binary analyzer 100 from the .rodata section of the binary:

TABLE 2
Character Strings Extracted from Target Binary
[‘ASCII’, ‘CHARSET’, ‘UTF-8’, ‘1.38’, ‘Nameprep’, ‘xn--’,
‘/usr/share/locale’, ‘libidn’, ‘Success’, ‘String preparation failed’, ‘Punycode failed’, ‘Cannot
allocate memory’, ‘System dlopen failed’, ‘Unknown error’, ‘Invalid input’, ‘String size limit
exceeded’, ‘Flag conflict with profile’, ‘Unknown profile’, ‘Missing
input’, ‘KRBprep’, ‘Nodeprep’, ‘Resourceprep’, ‘plain’, ‘trace’, ‘SASLprep’, ‘ISCSIprep’, ‘iSCSI’,
‘p0q0’, ‘s0t0’, ‘v0w0’, ‘y0z0’, ‘|0}0’, ‘\tG\x0BK\x0BG\x0BH\x0BG\x0BL\x0B’, ‘\fF\rJ\rF\rL\r’, ‘<\t)\
t<\t1\t<\t4\t’, ‘\x0BV\fH\f’, ‘\f>\rK\r’, ‘VIII’, ‘viii’, ‘(10)’, ‘(11)’, ‘(12)’, ‘(13)’, ‘(14)’, ‘(15)’, ‘(16)’, ‘(17)’,
‘(18)’, ‘(19)’, ‘(20)’, ‘kcal’, ‘a.m.’, ‘p.m.’,’] \x0Ba\n’, ‘&’‘\n3’, ‘0’‘\x0B3’, ‘:’‘\f3’, ‘D’‘\r3’,
‘P#3’, ‘]#!3’, ‘m#’‘3’, ‘}##3’, ‘$$13’, ‘.$23’, ‘8$33’, ‘K$43’, ‘X$53’, ‘k$63’, ‘u$73’, ‘%%E3’, ‘/%F3’,
‘9%G3’, ‘C%H3’, ‘S%I3’, ‘'%J3’, ‘g%K3’, ‘z%L3’, ‘\r&X3’, ‘!&[3’, ‘&&\\3’, ‘+&]3’, ‘0&?3’,
‘5&_3’, ‘:&'3’, ‘?&a’, ‘D&b3’, ‘I&c3’, ‘O&d3’, ‘U&e3’, ‘[&f3’, ‘a&g3’, ‘g&h3’, ‘m&i3’, ‘s&j3’, ‘y&k3’,
‘\n\x0B\f\r’, ‘kkkk’, ‘zzzz’, ‘Non-digit/letter/hyphen in input’, “Forbidden leading or trailing minus sign (‘−’)”,
‘Output would be too large or too small’, “Input does not start with ACE prefix (‘xn--’)”,
‘String not idempotent under ToASCII’, “Input already contain ACE prefix (‘xn--’)”,
‘Character encoding conversion error’, ‘String not idempotent under Unicode NFKC
normalization’, ‘Output would exceed the buffer space provided’, ‘Forbidden unassigned
code points in input’, ‘Prohibited code points in input’, ‘Conflicting bidirectional properties
in input’, ‘Malformed bidirectional string’, ‘Prohibited bidirectional code points in
input’, ‘Error in stringprep profile definition’, ‘Unicode normalization failed (internal
error)’, ‘Code points prohibited by top-level domain’, ‘No top-level domain found in input’]

Table 3 shown below illustrates an example of tokenization performed by binary analyzer 100 on the character strings illustrated in Table 2:

TABLE 3
Tokenized Character Strings

[′ascii′, ′charset′, ′locale′, ′krbprep′, ′saslprep′, ′iscsiprep′, ′iscsi′, ′viii′, ′nonxxpadxx′,
′toascii′, ′nfkc′, ′topxxpadxx′, ′top-level′, ′topxxpadxx′, ′top-level′, ′libidn′]

Table 4 shown below illustrates vectorization performed by binary analyzer 100 of the tokens illustrated in Table 3.

TABLE 4
Vectorized Character Strings

columns: [49665 87499 96696 133606 210153 248434 267567 301833 539588.
669750 689624 870858 1040193 368885]
values: [0.06666667 0.06666667 0.06666667 0.06666667 0.06666667 0.06666667
0.13333333 0.06666667 0.06666667 0.06666667 0.06666667 0.13333333
0.06666667 0.06666667]

### Exported Functions

Table 5 shown below illustrates an example of exported function names that may be extracted by binary analyzer 100 from the .dynsym .symtab 5 portions of a ground truth binary.

TABLE 5
Exported Function Names

[′stringprep_4zi′, ′stringprep_unichar_to_utf8′, ′idna_to_ascii_lz′, ′tld_check_4t′, ′idn_free′,
′tld_check_8z′, ′stringprep_ucs4_nfkc_normalize′, ′stringprep_convert′, ′pr29_8z′, ′tld_
strerror′, ′tld_check_4z′, ′pr29_4z′, ′stringprep_utf8_to_unichar′, ′idna_to_ascii_4i′, ′tld_get_4z′,
′idna_to_unicode_8z8z′, ′stringprep_ucs4_to_utf8′, ′idna_to_unicode_Izlz′, ′stringprep_utf8
nfkc_normalize′, ′idna_to_unicode_8z4z′, ′tld_check_4tz′, ′pr29_4′, ′stringprep_locale_to
utf8′, ′punycode_decode′, ′stringprep_strerror′, ′tld_get_4′, ′idna_to_ascii_8z′, ′tld_get_z′, ′
stringprep′, ′idna_to_ascii_4z′, ′stringprep_locale_charset′, ′tld_default_table′, ′punycode_
encode′, ′stringprep_profile′, ′stringprep_utf8_to_ucs4′, ′stringprep_utf8_to_locale′,
′punycode_strerror′, ′idna_to_unicode_44i′, ′tld_check_lz′, ′idna_to_unicode_4z4z′, ′tld_get_table′,
′tld_check_4′, ′idna_to_unicode_8zlz′, ′stringprep_4i′, ′idna_strerror′, ′stringprep_check_
version′, ′pr29_strerror′]

The tokenization of the exported function names is identical to extracted data because all of the exported functions are deemed to be important.

Table 6 shown below illustrates vectorization of the exported function names performed by binary analyzer 100.

TABLE 6
Vectorization of Exported Function Names

columns [11314 25014 31019 40624 47331 48541 52850 92096 130914
154903 184263 192941 213089 231421 276932 287716 303181 323296.
373444 463916 516376 542121 549149. 549296 577043 588802 596769.
608405 610531 659579 665769 714859 741733 742725 780165 781390.
801853 855416 881712 937469 940484 963322 983735 1007519 1027119.
1031766 1038894]
values [1. 1. 1. 1. 1. 1. 1. 1. 1. 1. 1. 1. 1. 1. 1. 1. 1. 1. 1. 1. 1. 1. 1. 1. 1. 1. 1. 1. 1. 1. 1.
1. 1. 1. 1. 1. 1. 1. 1. 1. 1. 1. 1. 1. 1. 1. 1.]

It should be noted from Table 6 that each exported function name has a count of 1, because function names are exported only once.

The following section illustrates exemplary steps that may be performed by similarity matcher 110 in identification of binary, i.e., identifying a software component present in a target binary file, such as a target binary image file with unknown content.

### Identification of a Binary

### Vectorize Binary

The first step that may be performed by similarity matcher 110 is vectorizing target binary 112. In vectorizing target binary 112, similarity matcher 110 may perform the same steps described above with regard to generating vectorized database 108. These steps include extracting strings and exported function names, tokenizing the strings and exported function names, and generating vectors for each of the generated tokens to generate a query matrix TF_{q}.

The next step in identifying the target binary is to compare the vectors generated for target binary 112 to the vectors in vectorized database 108. Similarity matcher 110 may perform the following steps in making the comparison:

### Strings

1. Calculate TF_{q}-IDF_{b} from TF_{q}*baseline IDF
2. Trim TF_{q}-IDF_{b} to retain only non-zero columns from baseline TF_{b}-IDF_{b}
3. Aggregate the most similar N rows are aggregated based on a similarity function. In example, similarity matcher 110 calculates the cosine similarity between query TF_{q}-IDF_{b} and baseline TF_{b}-IDF_{b}. An example of a cosine similarity function that can be used is found at the following URL:

https://scikit-learn.org/stable/modules/generated/
sklearn.metrics.pairwise.cosine_similarity.html

Similarity matcher 110 may perform the following steps with respect to calculating the cosine similarity:
   a. find cosine similarity S_{c}=A·B/|A∥B|; and
   b. N is arbitrarily set to reduce the number of row specific operations matching operations.
4. From the most similar N rows
   a. slice the row from baseline TF_{b}-IDF_{b}→TF_{b}-IDF_{b}[x]
   b. set all values to 1 in both query and baseline matrices
   c. scale by arbitrary weight factor 10, both query and baseline row X by scaled tokens matrix

$$Scale weight SW = non - zero columns of {TF}_{q} - {IDF}_{b} / 10$$

$$Scaled query {TF}_{qST} - {IDF}_{b} = TFq - {IDF}_{b}^{*} {ST [ x ]}^{*} SW + TFq - {IDF}_{b} Scaled baseline {TF}_{bST} - {IDF}_{b} [ x ] = {TF}_{b} - {IDF}_{b}^{*} {ST [ x ]}^{*} SW + {TF}_{b} - {IDF}_{b}$$

d. find cosine similarity (scaled Jaccard similarity) between scaled query TF_{qST}-IDF_{b} and scaled baseline TF_{bST}-IDF_{b}[x]
e. return scores and row indices where score>arbitrary threshold of 0.8

### Exported Functions

Similarity matcher 110 may perform the following steps for determining the similarity match for exported functions for target binary 112. This match type is only applicable for shared object/library binaries.
1. find cosine similarity between query TF_{q} and baseline TF_{b} (Jaccard similarity since all value are 1); and
2. return scores and row indices where score<arbitrary threshold of 0.8.

### Correlation

After identifying the N most similar matches from database 108, similarity matcher 110 may perform the following steps to select the identification of the target binary from the N most similar matches.

### Strings

Strings matching the threshold described above are cross correlated with
1. binary filename. If query binary name matches the baseline filename. Result sets are returned in the following priority order: strings+filename>strings.

### Exported Functions

Exported functions matching the threshold described above are cross correlated with:
1. binary filename. If query binary name matches the baseline filename; and
2. string match. If the query strings data also matches the same package above arbitrary threshold.
   Result sets are returned in the following priority order:

exported_funcs + strings + filename > exported_funcs + strings >
exported_funcs + filename > exported_funcs.

The following examples illustrate operations performed by similarity matcher 110 in identifying a target binary.

### EXAMPLE

### Strings

Table 7 illustrates .rodata extraction by similarity matcher 110 from target binary 112:

TABLE 7
Strings Data Extracted from Target Binary

[′\n\x0b\x0c\r′, ′kkkk′, ′zzzz′, ′]\x0ba\n′, ′&″\n3′, ′0″\x0b3′, ′:″\x0c3′, ′D″\r3′, ′P# 3′, ′]#!3′,
′m#″3′, ′}##3′, ′$$13′, ′.$23′, ′8$33′, ′K$43′, ′X$53′, ′k$63′, ′u$73′, ′%%E3′, ′/%F3′,
′9%G3′, ′C%H3′, ′S%I3′, ′′%J3′, ′g%K3′, ′z%L3′, ′\r&X3′, ′!&[3′, ′&&\\3′, ′+&]3′, ′0&\hat{ }3′,
′5&_3′, ′:&′3′, ′?&a3′, ′D&b3′, ′I&c3′, ′O&d3′, ′U&e3′, ′[&f3′, ′a&g3′, ′g&h3′, ′m&i3′, ′s&j3′,
′y&k3′, ′VIII′, ′viii′, ′(10)′, ′(11)′, ′(12)′, ′(13)′, ′(14)′, ′(15)′, ′(16)′, ′(17)′, ′(18)′, ′(19)′, ′(20)′,
′kcal′, ′a.m.′, ′p.m.′, ′<\t)\t<\t1\t<\t4\t′, ″\x0bV\x0cH\x0c′, ″\x0c>\rK\r′,
′\tG\x0bK\x0bG\x0bH\x0bG\x0bL\x0b′, ′\x0cF\rJ\rF\rL\r′, ′p0q0′, ′s0t0′, ′v0w0′, ′y0z0′,
′|0}0′, ′0ASCII′, ′CHARSET′, ′UTF-8′, ′1.32′, ′Nameprep′, ′KRBprep′, ′Nodeprep′,
′Resourceprep′, ′plain′, ′trace′, ′SASLprep′, ′ISCSIprep′, ′iSCSI′, ′xn--′, ′/usr/share/locale′,
′libidn′, ′Success′, ′String preparation failed′, ′Punycode failed′, ′Non-digit/letter/hyphen
in input′, ″Forbidden leading or trailing minus sign (′-′)″, ′Output would be too large or
too small′, ″Input does not start with ACE prefix (′xn--′)″, ′String not idempotent under
ToASCII′, ″Input already contain ACE prefix (′xn--′)″, ′Could not convert string in locale
encoding′, ′Cannot allocate memory′, ′System dlopen failed′, ′Unknown error′, ′String
not idempotent under Unicode NFKC normalization′, ′Invalid input′, ′Output would
exceed the buffer space provided′, ′String size limit exceeded′, ′Forbidden unassigned
code points in input′, ′Prohibited code points in input′, ′Conflicting bidirectional
properties in input′, ′Malformed bidirectional string′, ′Prohibited bidirectional code points
in input′, ′Error in stringprep profile definition′, ′Flag conflict with profile′, ′Unknown
profile′, ′Could not convert string in locale encoding.′, ′Unicode normalization failed
(internal error)′, ′Code points prohibited by top-level domain′, ′Missing input′, ′System
iconv failed′, ′No top-level domain found in input′]

Table 8 illustrates the results of tokenization of the strings data extracted from target binary 112.

TABLE 8
Tokenized Strings Data from Target Binary

[′viii′, ′charset′, ′krbprep′, ′saslprep′, ′iscsiprep′, ′iscsi′, ′locale′, ′nonxxpadxx′, ′toascii′,
′nfkc′, ′topxxpadxx′, ′top-level′, ′topxxpadxx′, ′top-level′, ′libidn′]

Table 9 illustrates vectorization of the strings data from the target binary to generate TF_{q}.

TABLE 9
Vectorization of Stings Data from Target Binary

columns:[87499 96696 133606 210153 248434 267567 301833 368885 539588
548700 669750 689624 870858 1040193]
values: [0.05882353 0.05882353 0.05882353 0.05882353 0.05882353 0.11764706
0.05882353 0.05882353 0.05882353 0.11764706 0.05882353 0.05882353
0.11764706 0.05882353]

Table 10 illustrates results TF_{q}-IDF_{b} of comparing the vectorized strings data from target binary 112 to the vectors in vectorized database 108.

TABLE 10
Results TF_{q}-IDF_{b} of Comparing the Vectorized Strings Data from
Target Binary to Vectors in Vectorized Database

columns: [87499 133606 210153 248434 301833 368885 539588 669750
870858. 1040193]
values: [0.19521088 0.18951029 0.16144434 0.18091453 0.20256022 0.21291853.
0.16936778 0.17750324 0.24956523 0.12689512]

Table 11 illustrates values of ST[x] for given row X

TABLE 11
Vaues of ST[X] for Row X

columns: [176628 368885 839349 839349 839349 839349 839349 839349
839349 86473. 471943 628329 840468 948600 422052 559095 721419 818593
843256]
values: [1. 1. 1. 1. 1. 1. 1. 1. 1. 1. 1. 1. 1. 1. 1. 1. 1. 1. 1.]

Table 12 illustrates an example of a scaled query row TF_{q}-IDF_{b}[x]

TABLE 12
scaled query row TFq-IDF_{b}[x]

columns: [87499 133606 210153 248434 301833 368885 539588 669750
columns: [87499 133606 210153 248434 301833 368885 539588 669750
870858
1040193 87499 133606 210153 248434 301833 368885 539588 669750
870858 1040193 87499 133606 210153 248434 301833 368885 539588
669750 870858 1040193 87499 133606 210153 248434 301833 368885
539588 669750 870858 1040193 87499 133606 210153 248434 301833
368885 539588 669750 870858 1040193 87499 133606 210153 248434
301833 368885 539588 669750 870858 1040193 87499 133606210153
248434 301833 368885 539588 669750 870858 1040193 87499 133606
210153 248434 301833 368885 539588 669750 870858 1040193 87499
133606 210153 248434 301833 368885 539588 669750 870858 1040193
87499 133606 210153 248434 301833 368885 539588 669750 870858
1040193]
values: [1. 1. 1. 1. 1. 2. 1. 1. 1. 1. 1. 1. 1. 1. 1. 1. 1. 1. 1. 1. 1. 1. 1. 1.
1. 1. 1. 1. 1. 1. 1. 1. 1. 1. 1. 1. 1. 1. 1. 1. 1. 1. 1. 1. 1.1. 1. 1.
1. 1. 1. 1. 1. 1. 1. 1. 1. 1. 1. 1. 1. 1. 1. 1. 1. 1. 1. 1. 1. 1. 1. 1.
1. 1. 1. 1. 1. 1. 1. 1. 1. 1. 1. 1. 1. 1. 1. 1. 1. 1. 1. 1. 1. 1. 1. 1.
1. 1. 1. 1.]

Table 13 illustrates an example of a scaled baseline row TF_{b}-IDF_{b}[x].

TABLE 13
Scaled Baseline Row TF_{b}-IDF_{b}[x]

columns: [87499 133606 210153 248434 301833 368885 539588 669750
870858
1040193 124604 239812 304778 597701 783144 827978 1004804 1024750
7000 33275 62626 124604 209227 262385 387648 417338 454796
563642 579083 683900 766623 875430 978618 1024750 7000 33275
62626 262385 417338 579083 978618 33275 305883 978618 1024750
181822 252825 475229 734194 821583 940050 243662 256168 334503
1047663]
values: [1. 1. 1. 1. 1. 2. 1. 1. 1. 1. 1. 1. 1. 1. 1. 1. 1. 1. 1. 1. 1. 1. 1. 1.
1. 1. 1. 1. 1. 1. 1. 1. 1. 1. 1. 1. 1. 1. 1. 1. 1. 1. 1. 1. 1. 1. 1. 1.
1. 1. 1. 1. 1. 1. 1.]

Note the value “2” in scaled rows, which matches the weighted token “libido”, which improves the match score slightly. The cosine similarity score is 99% in this case.

### Exported Functions

Table 14 illustrates results of exported function extraction from target binary 112.

TABLE 14
Results from Exported Function Extraction from Target Binary

[′stringprep_utf8_to_ucs4′, ′idna_to_unicode_8z8z′, ′stringprep_4i′, ′tld_get_z′,
′stringprep_locale_to_utf8′, ′tld_check_4′, ′stringprep_check_version′,
′idna_to_unicode_8z4z′, ′idna_strerror′, ′tld_default_table′, ′stringprep_strerror′,
′pr29_4′, ′stringprep_convert′, ′stringprep′, ′stringprep_utf8_nfkc_normalize′,
′stringprep_profile′, ′idna_to_ascii_8z′, ′idna_to_ascii_4i′, ′stringprep_ucs4_to_utf8′,
′tld_check_4tz′, ′stringprep_ucs4_nfkc_normalize′, ′stringprep_4zi′,
′idna_to_unicode_44i′, ′tld_get_table′, ′idna_to_unicode_8zlz′, ′idna_to_ascii_4z′,
′tld_check_8z′, ′tld_check_4t′, ′tld_get_4z′, ′tld_strerror′, ′pr29_strerror′, ′tld_check_4z′,
′tld_get_4′, ′idna_to_unicode_lzlz′, ′punycode_strerror′, ′stringprep_unichar_to_utf8′,
′pr29_8z′, ′idn_free′, ′stringprep_utf8_to_locale′, ′punycode_encode′, ′idna_to_ascii_lz′,
′idna_to_unicode_4z4z′, ′pr29_4z′, ′punycode_decode′,
′stringprep_locale_charset′, ′tld_check_lz′, ′stringprep_utf8_to_unichar′]

The tokenization of the exported function data is identical to extracted data.

Table 15 illustrates results of vectorization of the exported function tokens from target binary 112:

TABLE 15
Vectorization of Exported Function Data from Target Binary

columns: [11314 25014 31019 40624 47331 48541 52850 92096 130914
154903 184263 192941 213089 231421 276932 287716 303181 323296
373444 463916 516376 542121 549149 549296 577043 588802 596769
608405 610531 659579 665769 714859 741733 742725 780165 781390
801853 855416 881712 937469 940484 963322 983735 1007519 1027119
1031766 1038894]
values: [1. 1. 1. 1. 1. 1. 1. 1. 1. 1. 1. 1. 1. 1. 1. 1. 1. 1. 1. 1. 1. 1. 1. 1.
1. 1. 1. 1. 1. 1. 1. 1. 1. 1. 1. 1. 1. 1. 1. 1. 1. 1. 1. 1. 1. 1. 1.]

The cosine similarity score is 99% against libidn.so. 12.6.3 provided in source file example.

### Correlation

In this example, the exported function match of target binary 112 to libidn.so.12.6.3 is 100% and the strings match is 100%.

The query filename is libidn.so.6.15→extracted baseame “libidn”.
The match source file is/usr/lib/x86_64-linux-gnu/libidn.so. 12.6.3→extracted basename “libidn”.
The correlation match is the best case of exported_funcs+strings+filename.

### Version Identification

In addition to identifying the name of a target binary, the system illustrated in FIG. 1 may also identify the version number of the target binary. Version identification may be performed by emulation rules database generator 122 generating emulation rules database 124 and by version extractor 126 in identifying the version of a target binary from the rules in database 124. Version extractor 126 may extract version string from a target shared library binary (.so or .dll files). Emulation rules database generator 122 and version extractor 126 may perform the following operations to extract version strings from target binaries:
1—Emulation rules database generator 122: performs static binary analysis of ground truth shared library files to identify:
   a. Exported library APIs that could return version string when being called with specific arguments. For each library file there could be one or more such APIs.
   b. Exported library APIs that do not return version string but write it into log files or screen. For each library file there could be one or more such APIs. We refer to them as “version accessing functions” here.
2—Version extractor 126: uses the rules database generated by emulation rules database generator 122 to first find the names of version-returning or version-accessing functions. To facilitate further explanation, the term “version returning function”, as used herein is intended to refer to a function that returns a version string of a program or that writes a version string of the program to an I/O interface If version-returning function(s) were found, version extractor 126 locates that function body code in the target binary, then lifts (i.e., converts) that code into an intermediate code format, referred to as portable code or p-code (see https://en.wikipedia.org/wiki/P-code_machine) p-code “intermediate representation” and attempts to emulate this p-code until the function return instruction is encountered at which point, the emulator grabs the returned version value from the register or memory location based on the calling convention of the function.

The subject matter is not limited to using p-code as the intermediate code format for emulation. Any suitable intermediate code format that can be emulated, i.e., stepped through sequentially using an emulator, is intended to be within the scope of the subject matter described herein.

If version accessing function(s) were identified, version extractor 126 locates that function body code in the target binary, then lift that code into p-code “intermediate representation” but instead of performing full function emulation, version extractor 126 locates CALL p-code operation that writes the version string into the screen (such as printf, puts) or to the file. Version extractor 126 then extracts the function call arguments at this call site. The emulation rule contains the argument index of the version string that will be captured by the system.

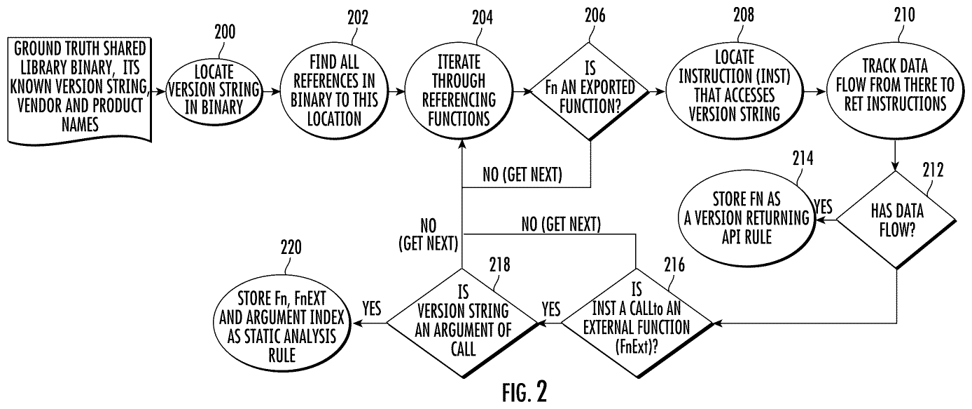

FIG. 2 is a flow chart illustrating an exemplary process performed by an emulation rules database generator 122 for generating rules for identifying software component versions. Referring to FIG. 2, in step 200, emulation rules database generator 122 locates the version string in a ground truth binary. In step 202, emulation rules database generator 122 finds all references in the binary to the location of the version string. In steps 204 and 206, emulation rules database generator 122 iterates through functions that reference the version string. If a given function is not an exported function, emulation rules database generator 122 goes to the next function. If the function is an exported function, control proceeds to step 208 where emulation rules database generator 122 locates instructions in the function that access the version string. In step 210, emulation rules database generator 122 tracks data flow from the located instructions to return instructions. In step 212, emulation rules database generator 122 determines whether the function has data flow. If the function has data flow, in step 214, the function is stored as a version-returning API rule in database 124.

In step 216, emulation rules database generator 122 determines whether an instruction is a call to an external function. If the instruction is not a call to an external function, control returns to step 204. If the function is a call to an external function, control proceeds to step 218, where emulation rules database generator 122 determines whether the version-returning the version string is an argument of the call. If the version string is not an argument of the call, control returns to step 204. If the version string is an argument of the call, control proceeds to step 220 where the function, the external function, and the argument are stored in database 124 as a static versioning analysis rule.

In one example, the ground truth binary is libnss3.so with a known version value of 3.68.2. This binary together with the known version value is fed to the static binary analyzer (a component of emulation rules database generator 122) which uses data flow analysis and p-code evaluation to locate the following version-returning function, name its return data type, calling convention and arguments if there were any:
Function name: NSS_GetVersion
Calling convention: _stdcall
Return data type: char *
Number of arguments: 0
   This information is recorded in emulation rules database 124 for that particular library identified by its vendor name (Mozilla) and product name (nss). This database that contains function information of various open source and closed-source libraries is then pushed into product deployments via update channels.

### Example of Version Extraction Using Code Emulation

On the deployed product, whenever the program level detector identifies the vendor and product name of shared library binary, it then invokes the version extractor sub-system. In the case of the libnss3.so, version extractor 126 will be invoked as follows:
ver_string_extractor libnss3.so mozilla nss
   Version extractor 126 will then query emulation rules database 124 and determine the aforementioned version-returning API information. Version extractor 126 then initializes its p-code emulator, sets up an emulation context, and starts emulating the version-returning API until the return opcode is reached at which point the returned version string (of type char *) is captured from the CPU register and returned.

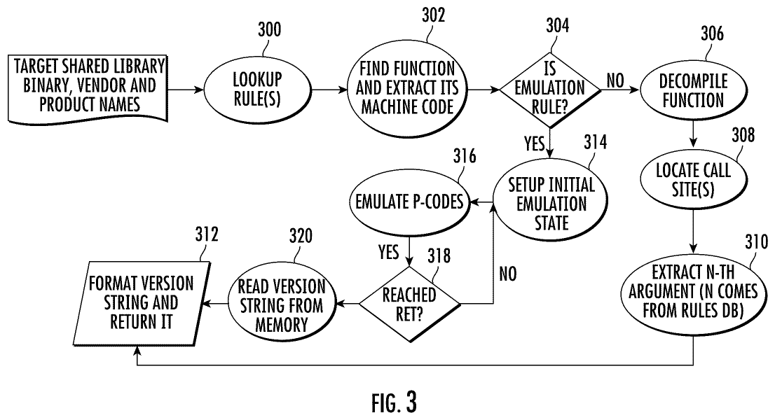

FIG. 3 is a flow chart illustrating an exemplary process for using emulation or static analysis rules to identify a version of a software component. Referring to FIG. 3, in step 300, version extractor 126 accesses version extraction lookup rules. In step 302, version extractor 126 finds a function and extracts its machine code from the target binary. In step 304, version extractor 126 determines whether the function corresponds to an emulation rule. If the function does not correspond to an emulation rule, control proceeds to step 306 where version extractor 126 decompiles the function. In step 308, version extractor 126 locates call sites for the function. In step 310, version extractor 126 extracts the int argument of the function from the rules database. In step 312, version extractor 126 formats the version string and returns the version string.

Returning to step 304, if the function corresponds to an emulation rule, control proceeds to step 314 where version extractor 126 sets up the initial emulation state. In step 316, version extractor 126 emulates p-code. In step 318, version extractor 126 determines whether the function has reached a return code. If the function has not reached the return code, emulation of the function continues once the function reaches a return code, control proceeds to step 320 where version extractor 126 reads the version string from memory. Control then returns to step 312 where version extractor 126 formats and returns to the version string.

The disclosure of the web pages referenced by each of the URLs included herein is incorporated by reference in its entirety.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for identifying software components of binary files, the method comprising:
generating, from ground truth binary files, a vectorized database of vectors representing program level features of the ground truth binary files;
receiving, as input, a target binary file to be analyzed;
vectorizing the target binary file to generate vectors representing program level features of the target binary file;
comparing the vectors generated from the target binary file to the vectors in the vectorized database;
identifying version-returning functions based on data flow analysis of the target binary file and emulating execution of at least one of the version-returning functions to identify a version string that identifies a version of a program implemented by the target binary file;
generating, as output and based on results of the comparing, at least one identity of at least one software component of the target binary file; and
outputting the version string.

2. The method of claim 1 wherein generating the vectorized database of vectors representing the program level features of the ground truth binary files includes identifying strings accessed by code and names of exported functions of the ground truth binary files.

3. The method of claim 1 wherein receiving, as input, the target binary file to be analyzed includes receiving the target binary file obtained from scanning firmware for executable files or library files.

4. The method of claim 1 wherein vectorizing the target binary file to generate vectors representing program level features of the target binary file includes identifying strings accessed by code and names of exported functions of the target binary file.

5. The method of claim 1 wherein comparing the vectors generated from the target binary file to the vectors in the database, includes generating a similarity metric quantifying similarity between a feature vector generated from the target binary file and a feature vector in the database.

6. The method of claim 5 wherein generating the similarity metric includes generating a cosine similarity metric.

7. The method of claim 1 wherein generating, as output and based on results of the comparing, at least one identity of at least one software component in the target binary file includes identifying a software component library name based on the results of the comparison.

8. The method of claim 1 comprising generating an emulation rules database by analyzing the ground truth binary files to return names of version-returning functions from the ground truth binary files that return a version string when called with specified arguments.

9. The method of claim 8 comprising attempting to identify a version string from the target binary file by analyzing the target binary file to identify the presence of one of the version-returning functions having its name recorded in the emulation rules database and that returns a version string or writes the version string to a file or an I/O interface and wherein emulating execution of at least one of the version-returning functions to identify a version string that identifies the version of the program implemented by the target binary file includes emulating execution of the at least one version-returning function to obtain the version string returned or written to an input/output (I/O) interface by the at least one version-returning function.

10. The method of claim 9 wherein emulating execution of at least one of the version-returning functions to obtain the version string includes locating binary code for the at least one version-returning function in the target binary file, converting the binary code for the version-returning function into an intermediate code format, emulating execution of the version-returning function in the intermediate code format, and obtaining the version string resulting from emulation of the version-returning function in the intermediate code format.

11. A system for identifying software components of binary files, the system comprising:
a computing platform including at least one processor and memory;
a binary analyzer implemented by the at least one processor for generating, from ground truth binary files, a vectorized database of vectors representing program level features of the ground truth binary files and storing the vectorized database in the memory;
a similarity matcher implemented by the at least one processor for receiving, as input, a target binary file to be analyzed, vectorizing the target binary file to generate vectors representing program level features of the target binary file, comparing the vectors generated from the target binary file to the vectors in the vectorized database, and generating, as output and based on the results of the comparing, at least one identity of at least one software component of the target binary file; and
a version extractor for identifying version-returning functions based on data flow analysis of the target binary file and emulating execution of at least one of the version-returning functions to identify a version string that identifies a version of a program implemented by the target binary file and outputting the version string.

12. The system of claim 11 wherein the binary analyzer is configured to generate the vectorized database of vectors representing the program level features of the ground truth binary files includes identifying strings accessed by code and names of exported functions of the ground truth binary files.

13. The system of claim 11 wherein the target binary file to be analyzed is obtained from scanning firmware for executable files or library files.

14. The system of claim 11 wherein the binary analyzer is configured to vectorize the target binary file to generate vectors representing program level features of the target binary file by identifying strings accessed by code and names of exported functions of the target binary file.

15. The system of claim 11 wherein the similarity matcher is configured to compare the vectors generated from the target binary file to the vectors in the database by generating a similarity metric quantifying similarity between a feature vector generated from the target binary file and a feature vector in the database.

16. The system of claim 15 wherein the similarity metric comprises a cosine similarity metric.

17. The system of claim 11 comprising an emulation rules database generator for generating an emulation rules database by analyzing the ground truth binary files to return names of version-returning functions from the ground truth binary files that return a version string when called with specified arguments.

18. The system of claim 17 wherein the version extractor is configured for attempting to identify a version string from the target binary file by analyzing the target binary file to identify the presence of one of the version-returning functions having its name recorded in the emulation rules database and that returns a version string or writes the version string to a file or an I/O interface and wherein emulating execution of at least one of the version-returning functions to identify a version string that identifies the version of the program implemented by the target binary file includes emulating execution of the at least one version-returning function to obtain the version string returned or written to an input/output (I/O) interface by the at least one version-returning function.

19. The system of claim 18 wherein the version extractor is configured to emulate execution of at least one of the version-identifying functions to obtain the version string by locating binary code for the version-returning function in the target binary file, converting the binary code for the version-returning function into an intermediate code format, emulating execution of the version-returning function in the intermediate code format, and obtaining the version string resulting from emulation of the version-returning function in the intermediate code format.

20. A non-transitory computer readable medium having stored thereon executable instructions that when executed by a processor of a computer controls the computer to perform steps comprising:
generating, from ground truth binary files, a vectorized database of vectors representing program level features of the ground truth binary files;
receiving, as input, a target binary file to be analyzed;
vectorizing the target binary file to generate vectors representing program level features of the target binary file;
comparing the vectors generated from the target binary file to the vectors in the vectorized database;
identifying version-returning functions based on data flow analysis of the target binary file and emulating execution of at least one of the version-returning functions to identify a version string that identifies a version of a program implemented by the target binary file;
generating, as output and based on the results of the comparing, at least one identity of at least one software component of the target binary file; and
outputting the version string.
